(19) United States
(12) Patent Application Publication
(10) Pub. No.: US 2007/0029012 A1
(43) Pub. Date: Feb. 8, 2007

(54) WORK TABLE HAVING MEANS FOR HOLDING THE DETACHED TABLE EXTENSION IN PLACE

(75) Inventors: Chia-Sheng Liu, Chiayi County (TW); Ming-Feng Liao, Taichung County (TW)

Correspondence Address: BACON & THOMAS, PLLC, 625 SLATERS LANE, FOURTH FLOOR, ALEXANDRIA, VA, 22314, US

(73) Assignee: Durq Machinery Corp., Taichung (TW)

(21) Appl. No.: 11/319,635

(22) Filed: Dec. 29, 2005

(30) Foreign Application Priority Data
Aug. 2, 2005 (TW) 094213149

(51) Int. Cl. B25H 1/00

(52) U.S. Cl. 144/286.5; 144/287

(57) ABSTRACT

A worktable includes a base on which a main table is supported, two guide rails arranged at two sides of the main table, a table extension slidably coupled to the guide rails, a locking structure provided at the table extension for locking the table extension to the guide rails, and a positioning structure provided at one lateral sidewall of the base for holding the table extension after removal of the table extension from the guide rails.

### BACKGROUND OF THE INVENTION

1. Field of the Invention

The present invention relates to a worktable having a detachable table extension and more particularly, to such a worktable that has means to hold the detached table extension firmly in place.

2. Description of the Related Art

FIG. 1 shows a conventional table saw 1. The table saw 1 comprises a machine base 2, a worktable 3 provided at the top of the machine base 2, two guide rails 4 arranged in parallel at two opposite lateral sides of the worktable 3, a table extension 5 provided at one side of the worktable 3 and forwardly and backwardly movable along the guide rails 4 relative to the worktable 3. The table extension 5 can be detached from the table saw 1 to reduce the packing size during delivery. The table extension 5 can also be detached from the table saw 1 and then attached to the other side of the worktable 3 for continuous use.

However, because the table saw 1 has no storage means to keep the detached table extension 5, it is an embarrassment to pack the detached table extension and to keep it in place during delivery of the table saw 1. More particularly, the table extension 5 shown in FIG. 1 comprises a sliding board 5a and an index plate 5b. During delivery, the index plate 5b may slide relative to the sliding board 5a, causing a trouble to the delivery and packing work.

Therefore, it is desirable to provide a measure to keep the detached table extension properly.

### SUMMARY OF THE INVENTION

The present invention has been accomplished under the circumstances in view. It is one object of the present invention to provide a worktable, which has means for holding the detached table extension in place.

To achieve this object of the present invention, the worktable comprises a base on which a main table is supported, two guide rails fastened to two opposite lateral sides of the main table and arranged in parallel, a table extension provided with a first side edge and a second side edge and coupled to the guide rails and reciprocally movable along the guide rails relative to the main table in a first direction, a locking structure fixedly provided at the table extension and having a press portion contactable with one of the guide rails to lock the table extension to the guide rails, and a positioning structure provided at a sidewall of the base for holding the table extension after removal of the table extension from the guide rails. The positioning structure comprises at least one locating block for stopping against the press portion of the locking structure and two clamping portions for clamping on the first side edge and second side edge of the table extension respectively to hold the table extension on the sidewall of the base after removal of the table extension from the guide rails.

### BRIEF DESCRIPTION OF THE DRAWINGS

FIG. 1 is a perspective view of a conventional table saw.

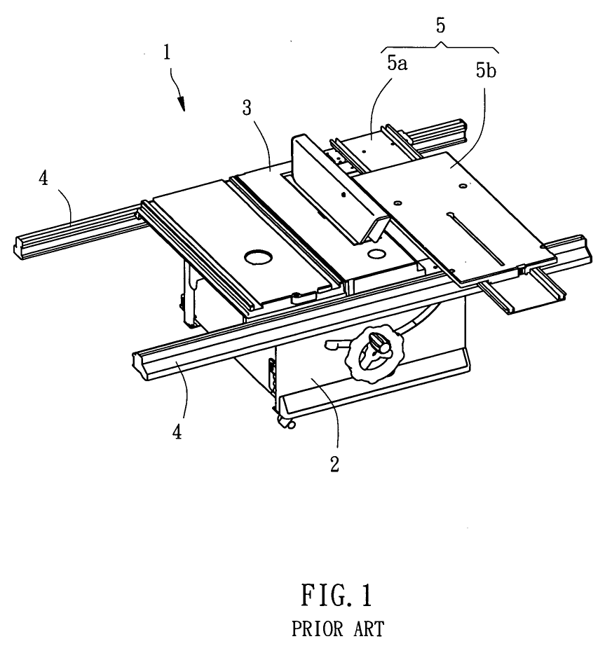

FIG. 2 is a perspective view of the preferred embodiment of the present invention.

FIG. 3 is a side view of the preferred embodiment of the present invention.

FIG. 4 is a bottom view of the table extension according to the present invention.

FIG. 5 is a schematic drawing showing the relative positioning between the detached table extension and the positioning structure at one sidewall of the base of the worktable according to the present invention.

FIG. 6 corresponds to FIG. 5, showing the detached table extension secured to the positioning structure at one sidewall of the base of the worktable according to the present invention.

FIG. 7 is a bottom view of a part of the present invention, showing the detached table extension secured to the positioning structure at one sidewall of the base of the worktable according to the present invention.

### DETAILED DESCRIPTION OF THE INVENTION

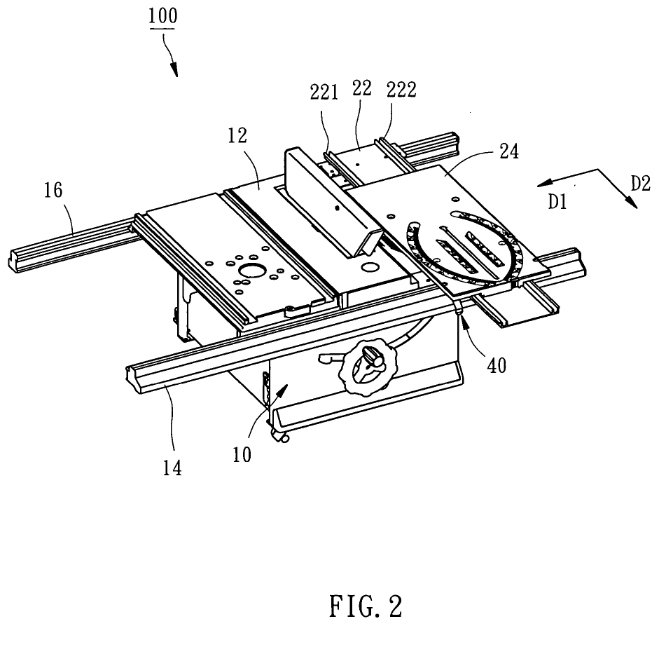

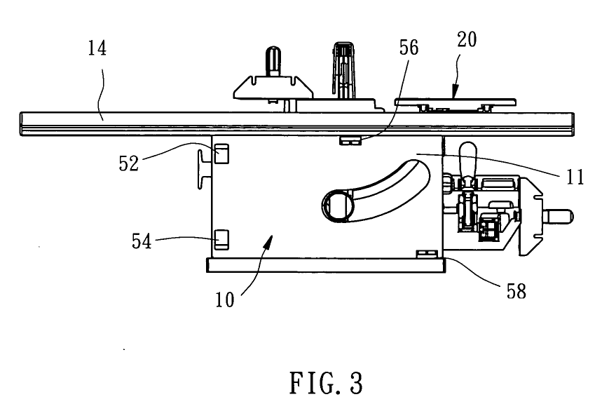

Referring to FIGS. 2-4, a worktable 100 in accordance with the present invention is shown comprising a base 10, a main table 12, two guide rails 14, 16, a table extension 20, a locking structure 40, and a positioning structure 50.

The main table 12 is provided at the top side of the base 10. The two guide rails 14, 16 are coupled to two opposite lateral sides of the main table 12 and arranged in parallel.

The table extension 20 is slidably coupled to the two guide rails 14, 16 and disposed at one side of the main table 12. According to this embodiment, the table extension 20 comprises a sliding board 22, an index plate 24, and two wear-resistant pads 25.

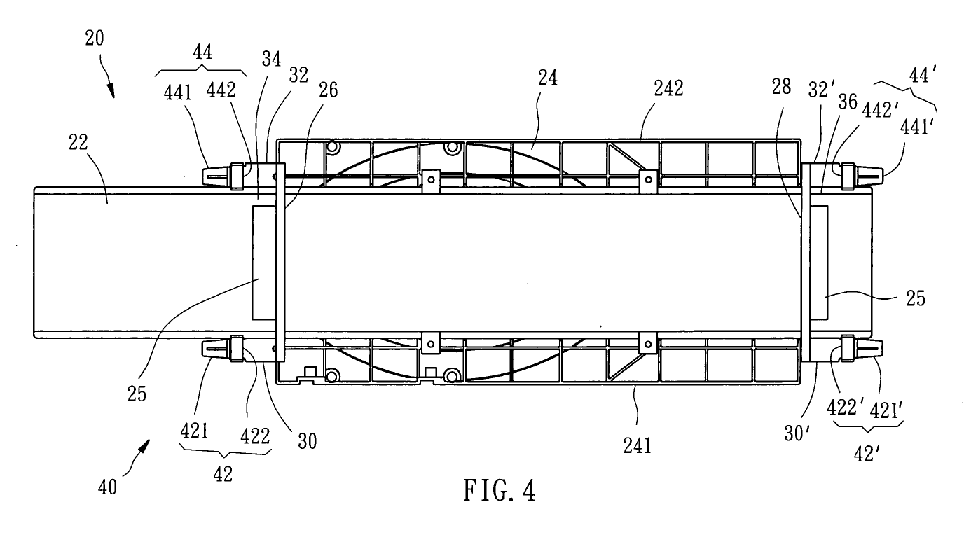

The sliding board 22 is a rectangular board longer than the width of the main table 12, having two parallel rails 221, 222 arranged at the top side, two transverse rods 26, 28 arranged at the bottom side, and two pairs of connectors 30(30′), 32(32′) symmetrically bilaterally provided at the ends of the transverse rods 26, 23 relative to two opposite lateral sides of the sliding board 22. As shown in FIG. 4, the transverse rod 26 and the connectors 30, 32 define a first coupling groove 34; the transverse rod 28 and the connectors 30′, 32′ define a second coupling groove 36. By means of coupling the first coupling groove 34 and the second coupling groove 36 to the guide rails 14, 16 respectively, the sliding board 22 is movable forwards and backwards in a first direction D1. The two wear-resistant pads 25 are fixedly fastened to the bottom side of the sliding board 22 corresponding to the first coupling groove 34 and the second coupling groove 36 to reduce wear between the bottom side of the sliding board 22 and the guide rails 14, 16.

The index plate 24 is coupled to the top side of the sliding board 22, and movable forwards and backwards in a second direction D2 along the two rails 221, 222. The two opposite long sides of the index plate 24 respectively form a first side edge 241 and a second side edge 242.

The locking structure 40 comprises two pairs of eccentric members 42, 44; 42′, 44′. As shown in FIG. 4, the first eccentric member 42 and second eccentric member 44 of the first pair are respectively pivoted to the connectors 30, 32 at one transverse rod 26. The first eccentric member 42′ and second eccentric member 44′ of the second pair are respectively pivoted to the connectors 30′, 32′ at the other transverse rod 28. The eccentric members 42, 42′, 44, 44′ each have a handle 421, 421′, 441, 441′ for operation by hand, and a press portion 422, 422′, 442, 442′. The press portions 422, 442 of the first and second eccentric members 42, 44 of the first pair are respectively projecting into the first coupling groove 34. The press portions 422′, 442′ of the first and second eccentric members 42′, 44′ of the second pair are respectively projecting into the second coupling groove 36. The sliding board 22 is forced by the press portions 422, 422′ of the first eccentric members 42, 42′ and the press portions 442, 442′ of the second eccentric members 44, 44′ against the rails 14, 16, thereby stopping on the rails 14, 16 at the desired location.

The positioning structure 50 is installed in one sidewall 11 of the base 10, comprising a fist locating block 52, a second locating block 54, a first retaining block 56, and a second retaining block 58.

The first locating block 52 has a recess 521 at one side, a stop flange 522 protruding from one side of the recess 521, and an outwardly protruding retaining portion 523.

The second locating block 54 is same as the first locating block 52, having a recess 541, a stop flange 542, and an outwardly protruding retaining portion 543.

The first retaining block 56 and the second retaining block 58 are same in structure, each comprising a clamping portion 561 or 581.

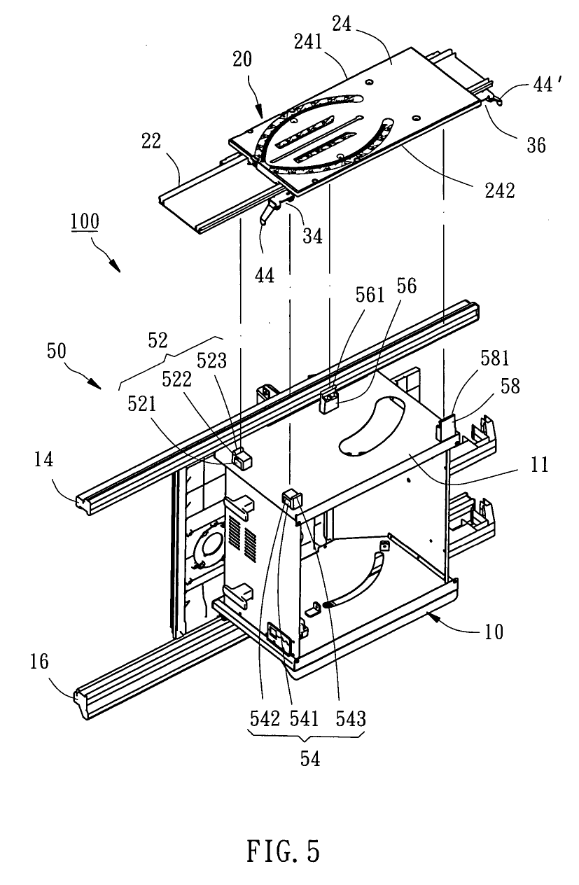

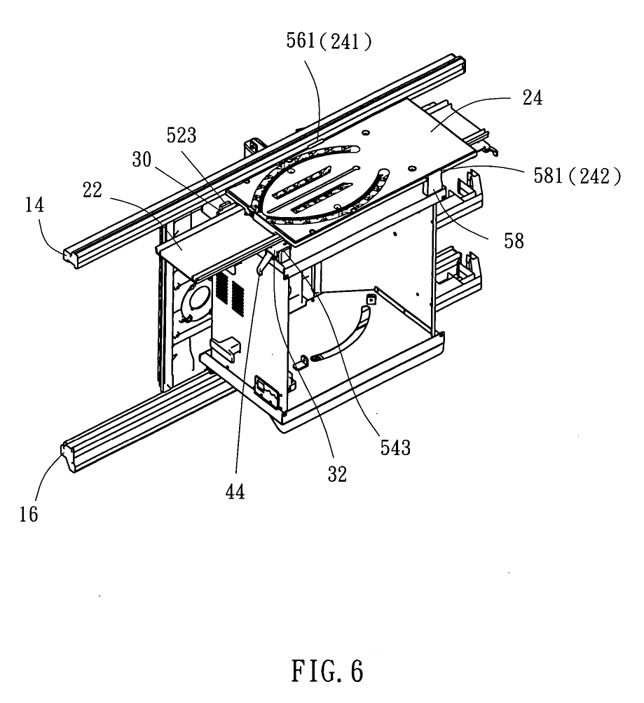

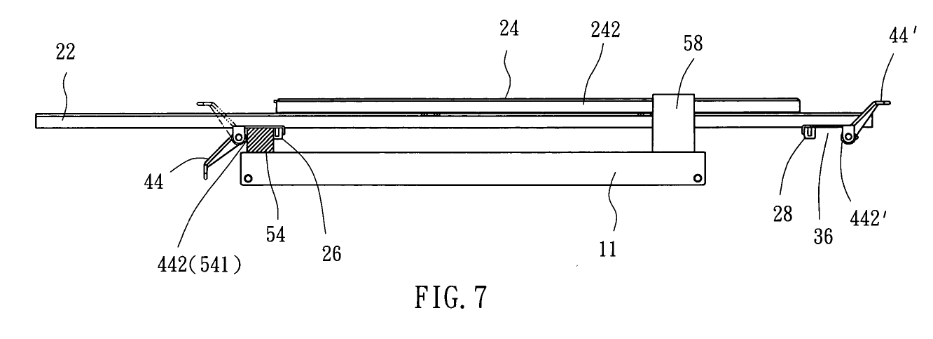

The above description explains the component parts of the worktable 100 and their relative relationship. In FIG. 2, the table extension 20 is mounted on the guide rails 14, 16 and worked with the main table 12 to support the workpiece. When detached the table extension 20 from the worktable 100 as shown in FIG. 5, the detached table extension 20 can be firmly secured to the sidewall 11 of the base 10. At this time, aim the first coupling groove 34 of the sliding board 22 to the first locating block 52 and the second locating block 54 and then press the table extension 20 in direction toward the base 10 to force the first coupling groove 34 into engagement with the first locating block 52 and the second locating block 54 as shown in FIGS. 6 and 7. At this time, the clamping portions 561, 581 of the retaining blocks 56, 58 are respectively clamped on the first side edge 241 and second side edge 242 of the index plate 24, and the outwardly protruding retaining portion 523, 543 of the locating blocks 52, 54 are respectively kept in contact with the connectors 30, 32. Thereafter, turn the eccentric members 42, 44 to force the respective press portions 422, 442 against the recesses 521, 541 of the first and second locating blocks 52, 54 respectively, and therefore the whole assembly of the table extension 20 is firmly secured to one side of the base 10 to facilitate delivery of the worktable 100.

Because the first eccentric member 42 and second eccentric member 44 of the table extension 20 are respectively stopped against the stop flanges 522, 542 of the first and second locating blocks 52, 54, the table extension 20 is firmly held down in place and will not escape from the base 10.

As stated above, under the condition of making no change of the structure of the table extension 20 and by means of the first coupling groove 34, the locking structure 40 and the positioning structure 50, the invention eliminates the problem of receiving the table extension 20 after dismounting of the table extension 20 from the worktable 100.

Although a particular embodiment of the invention has been described in detail for purposes of illustration, various modifications and enhancements may be made without departing from the spirit and scope of the invention. Accordingly, the invention is not to be limited except as by the appended claims.

1. A worktable comprising:
a base on which a main table is supported;
two guide rails fastened to two opposite lateral sides of said main table and arranged in parallel;
a table extension coupled to said guide rails and movable reciprocally along said guide rails relative to said main table in a first direction, said table extension having a first side edge and a second side edge;
a locking structure fixedly provided at said table extension and having at least one press portion contactable with one of said guide rails to lock said table extension to said guide rails; and
a positioning structure provided at a sidewall of said base for holding said table extension after removal of said table extension from said guide rails, said positioning structure comprising at least one locating block for stopping against the press potion of said locking structure, and two clamping portions for clamping on the first side edge and second side edge of said table extension respectively to hold said table extension on the sidewall of said base after removal of said table extension from said guide rails;
wherein said table extension comprises a first coupling groove and a second coupling groove at a bottom side thereof for coupling to said guide rails respectively; said locking structure comprises at least one eccentric member respectively pivoted to the bottom side of said table extension, said at least one eccentric member having said press portion and an operating handle, the press portion at said at least one eccentric member projecting into said first coupling groove; and
wherein the at least one locating block of said positioning structure is connectable to the first coupling groove of said table extension after removal of said table extension from said guide rails.

2. (canceled)

3. The worktable as claimed in claim 1, wherein said at least one eccentric member includes a first eccentric member and a second eccentric member; said at least one locating block includes a first locating block and a second locating block corresponding to said first eccentric member and said second eccentric member, said first locating block and said second locating block each having a recess at one side for receiving the press portions at said first eccentric member and said second eccentric member respectively.

4. The worktable as claimed in claim 3, wherein said table extension comprises a sliding board and an index plate; said first coupling groove and said second coupling groove are provided at a bottom side of said sliding board such that said sliding board is movable in said first direction, said index plate being coupled to said sliding board and movable reciprocally relative to said sliding board in a second direction perpendicular to said first direction; said first side edge and said second side edge of said table extension are provided at said index plate.

5. The worktable as claimed in claim 4, wherein said sliding board comprises at least one transverse rod at a bottom side thereof and two connectors provided at said transverse rod for pivotally respectively coupling said first eccentric member and said second eccentric member; said first coupling groove is defined between one of said at least one transverse rod and the press portions at said first eccentric member and said second eccentric member.

6. The worktable as claimed in claim 5, wherein said first locating block and said second locating block each comprise a retaining portion respectively stopped against said connectors.

7. The worktable as claimed in claim 3, wherein said first locating block and said second locating block each have a stop flange at one side of the respective recess for stopping against the press portions at said first and second eccentric members.

8. The worktable as claimed in claim 1, further comprising two wear-resistant pads respectively fixedly mounted on the bottom side of said table extension corresponding to said first coupling groove and said second coupling groove.

9. The worktable as claimed in claim 1, wherein said positioning structure comprises a first retaining block and a second retaining block; said two clamping portions are respectively provided at said first retaining block and said second retaining block.
